(19) United States
(12) Patent Application Publication
(10) Pub. No.: US 2013/0258799 A1
(43) Pub. Date: Oct. 3, 2013

(54) Method and Apparatus for Mixing Powder Material With Water

(71) Applicants: Richard W. Christy, Wayne, PA (US); Michael Quici, Ambler, PA (US)

(72) Inventors: Richard W. Christy, Wayne, PA (US); Michael Quici, Ambler, PA (US)

(73) Assignee: RDP TECHNOLOGIES, INC., Norristown, PA (US)

(21) Appl. No.: 13/438,196

(22) Filed: Apr. 3, 2012

(51) Int. Cl. B01F 15/02

(52) U.S. Cl. CPC B01F 15/0201
USPC 366/141

(57) ABSTRACT

A process and apparatus is provided for mixing a powder material with water. The powder material can be powdered activated carbon (PAC) or a dry polymer. The powder material is provided from a container, and it is delivered to a feed hopper, then to a mixing vessel, where water is provided, to mix with the powder material through a wetting ring. A vibrator mechanism may be used to facilitate discharge of the powder material into the feed hopper.

The powder material and water are mixed, in a mixing tank. When the powder material is a dry polymer, a variable speed mechanism may control the speed of the mixing.

Load cells can support the weight of the container, feed hopper and mixing tank, feeding such information to a computer.

### BACKGROUND OF THE INVENTION

It is known in the art to use certain powder materials treat water. For example, it is knows to use powered activated carbon to treat water. It is also known in the art to use a polymer material to treat water. The water being treated can be of almost any type, such as ground water, water from a stream, river or the like, sewage water, aquifer water, tap water, water from industrial applications, or the like. It is also known to provide water treatments to comply with governmental standards for water purification.

When water is to be treated with a polymer, the polymer can be made available in powered form, liquid form, or an emulation form. To the extent that this invention is directed to mixing a polymer with water, it is directed to the process and apparatus of using polymers in powder (particulate) form to be mixed with water. The powder form of a polymer is highly desirable, because the transport of polymers in powder form does not involve the additional weight and hence the expense that is required to transport polymers in liquid form.

Polymers in powder form are commonly referred to as dry polymers. Dry polymers may include small particles and/or polymer dust. They can be available and purchased commercially in bag or container form. However, dry polymers, in order to become diluted in water, must have their particles wet, to avoid lumping and resisting dissolution in water.

Powdered activate carbon is also available commercially in bag or container form.

### THE PRESENT INVENTION

The present invention is directed to mixing a dry powder material with water, for use in subsequent treatment operations.

### SUMMARY OF THE INVENTION

The present invention is directed to mixing in water, either powdered activated carbon, which may include very small granular particles of activated carbon (each of which are hereinafter referred to as PAC or a dry polymer which can also include small granular particles, with water. Whichever powder material is being mixed with water, it can be provided in bag form, or delivered from a silo, in each case the powder material being transferred from the bag or silo to a feed hopper that, in turn, transfers it to the feed screw of an auger or other transport device, that, in turn, delivers it to a mixing tank, in which water is provided.

Preferably, a vibrator is used to assist the discharge of the powder material from the bag or silo, into the feed hopper and such discharge is valve-controlled.

As the powder material enters the feed hopper, the hopper can be vented to allow displacement of air therefrom as the powder material is added to the hopper.

As the powder material is fed to a mixing tank, water is delivered, preferably via a wetting ring, in a controlled fashion, with the wetting ring having a plurality of discharge nozzles, for creating a partial vacuum and acting as an eductor, wetting the powder material entering the mixing tank.

The wetting ring facilitates blending of the powder material with the water by spraying water in with the powder material as it is fed to the mixing tank. Accurate weighing of the amount of powder material and water can be determined by the mounting of the mixing tank on load cells that transmits the weight of the same, together with the tank, preferably to a computer, for computer control of the mixing.

When the powder material and the water have reached a desired state of mixing, the mix can be stored in a storage vessel prior to being delivered through a dosing station. The dosing station can be either a single delivery dosing station or a multiple-delivery dosing station. Alternatively, the mix can be delivered to a subsequent treatment station.

Optionally, the mix from the storage vessel can be returned, in whole, or in part, back to the storage vessel if its dosing is not desired at that time.

Other aspects of the present invention will be apparent upon a reading of the following Brief Descriptions of the Drawing Figures, the Detailed Descriptions of the Preferred Embodiments and the appended claims.

### BRIEF DESCRIPTIONS OF THE DRAWING FIGURES

FIG. 1 is a schematic view of a system for mixing powder material with water, that addresses the issues discussed above.

FIG. 2 is an enlarged schematic illustration in vertical section of a holding tank for the mix and its optional delivery through a precision single or multiple dosing station, with an optional return to the storage or holding tank.

FIG. 2A is a fragmentary illustration of an alternative delivery of the mix from the holding tank directly to a treatment process.

FIG. 2B is yet another alternative delivery of the mix from the holding tank, through a magnetic flowmeter and a pinch valve, to a treatment process.

FIG. 2C is a fragmentary illustration of a variable speed control for the shaft of the impeller in the mixing tank, particularly when the powder material is a dry polymer.

FIG. 3 is a fragmentary vertical section of a silo for receiving and containing powder material for delivery to a feed hopper, as an alternative to the bag delivery of FIG. 1, wherein, as with the embodiment of FIG. 1 a vibrator system is provided for facilitating discharge of the powder material from the silo into the feed hopper.

### DETAILED DESCRIPTIONS OF THE PREFERRED EMBODIMENTS

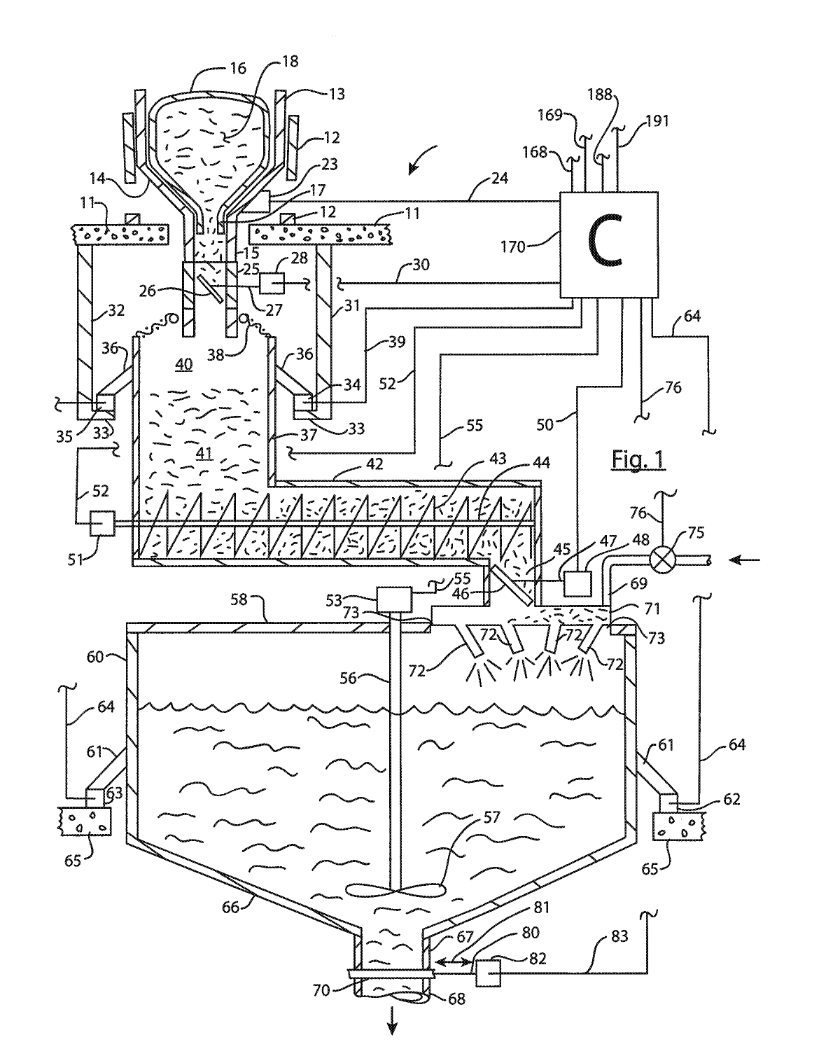

Referring now to the drawings in detail, reference is first made to FIG. 1, wherein the mixing system 10 for mixing the powder material, either in the form of powdered activated carbon, or a dry polymer, with water, is generally illustrated.

The system 10 includes a generally cylindrical holding member 12, vertically upstanding (shown broken away for clarity) from above a supporting floor 11, which floor can be concrete or other construction, in which the supporting structure 12 engages a periphery of a bag unloader 13, having a preferably funnel-shaped bottom 14, and with the unloader 13 having a discharge 15 therefrom, through which the powder material 18 contained within bag 16 is discharged via bag outlet 17 thereinto. A vibrating system in the form of an electric vibrating motor 23 is provided, attached to the unloader 13, preferably near the discharge 15. The vibrating motor 23 includes eccentrically mounted weights therein (not shown) that are adjustable to make the vibration more or less violent. This vibrating system provides the necessary vibration for facilitating discharge of the powder material 18 from the bag 16, with the motor 23 being controlled from a programmable logic computer 170 via control line 24.

The powder material 18 leaves the discharge 15 and enters through a valve 25, having a flapper or other mechanism 26 therein, openable and closable, in whole or in part, as determined by the movement of drive rod 27, as dictated by motor 28, that, in turn, is automatically computer-controlled, from computer 170, via line 30.

A feed hopper 37 has legs 36 mounted thereon, with those legs 36 being, in turn, carried on load cells 34, 35, that, in turn, are seatingly disposed on horizontal portions 33 of support legs 31, 32, that are carried by the above floor 11. Thus, the weight of the feed hopper 37, the powder material 41 disposed therein, and the feed mechanism 42 with powder material therein at the bottom of the feed hopper 37, as well as the wetting ring 71 as will be described hereinafter, all contribute to the weight that is disposed on the load cells 34, 35, the information of which is transferred to the computer 170 via the information line 39.

The load cells may be constructed as are the load cells in U.S. Pat. No. 7,669,348, or any one or more of U.S. Pat. Nos. 5,770,823; 4,064,744; 4,166,997; 4,454,770 and 5,313,022, the complete disclosures of which are herein incorporated by reference.

In order to facilitate entry of the powder material 18 from the bag 16, into the feed hopper 37, air in the upper portion 40 of the feed hopper 37, above the upper level of the powder material 41 in the feed hopper 37, is free to be discharged through a foraminous screen, cloth, mesh, filter or like upper end 38 of the feed hopper 37, which foraminous upper end may be comprised of any material that will allow ready movement of air from the zone 40, outwardly of the foraminous member 38, as the powder material 41 enters the feed hopper 37.

Within the horizontal powder material transport member 42, there is disposed an auger type screw 43, shaft mounted at 44, and driven via motor 51, that in turn is connected to the computer 170 via control line 52, for controlling the rightward movement of powder material along the feed screw, to the discharge location 45 therefrom.

Within the discharge location 45, a flapper or other valve member 46 is controlled via a control rod 47 from a motor 48, that, in turn, is controlled from computer 170 via control line 50.

The delivery of water from any given source, such as a stream, river, municipal water, aquifer, sewage waste water, tap water or industrial water site is supplied to a line 69, through a valve 75 that, in turn is controlled via control line 76 from computer 170, such that water entering a wetting ring 71 is delivered via a plurality of discharge nozzles 72, into the mixing or preparation tank 60.

Thus, the powder material 41 and water enter the mixing tank 60, with the water mingling with and wetting the small particles or powder form of the powder material 40 as it enters the vessel 60, so that all particles of the powder material become wet.

Within the mixing tank 60, a shaft 56 is disposed through the upper end 58 thereof, driven by an electric powered motor 53.

It will also be understood that the wetting ring 71 is not connected to the lid 58 of the mixing tank 60, but is somewhat spaced therefrom, as shown by the spacing zones 73 between the mixing ring 71 and the lid 58, such that the wetting ring 71, being carried by the transport device 42, is part of the weight that engages the load cells 34, 35 that support the feed hopper 37.

The mixing tank 60 is supported by supporting struts 61, as shown, that, in turn, are supported on load cells 62, 63, carried by a concrete or other floor 65, with the load cells 62, 63 conveying the weight information of the mixing tank 60, together with its structure, including the mixing mechanism therein and the water and the powder material therein, back to the computer 170, via transmission line(s) 64.

At the bottom of the mixing tank 60 there is a discharge conduit 67, facilitating the discharge of the thus treated water from the vessel 60, when the gate valve 70 is opened, as determined by its drive rod 80 being driven by motor 82, either backward or forward in the direction of the double-headed arrow 81, as determined by the computer 170 via control line 83.

The thus mixed powder material and water is delivered from the mixing tank 60 via discharge line 68 to inlet 148 of a storage vessel 151.

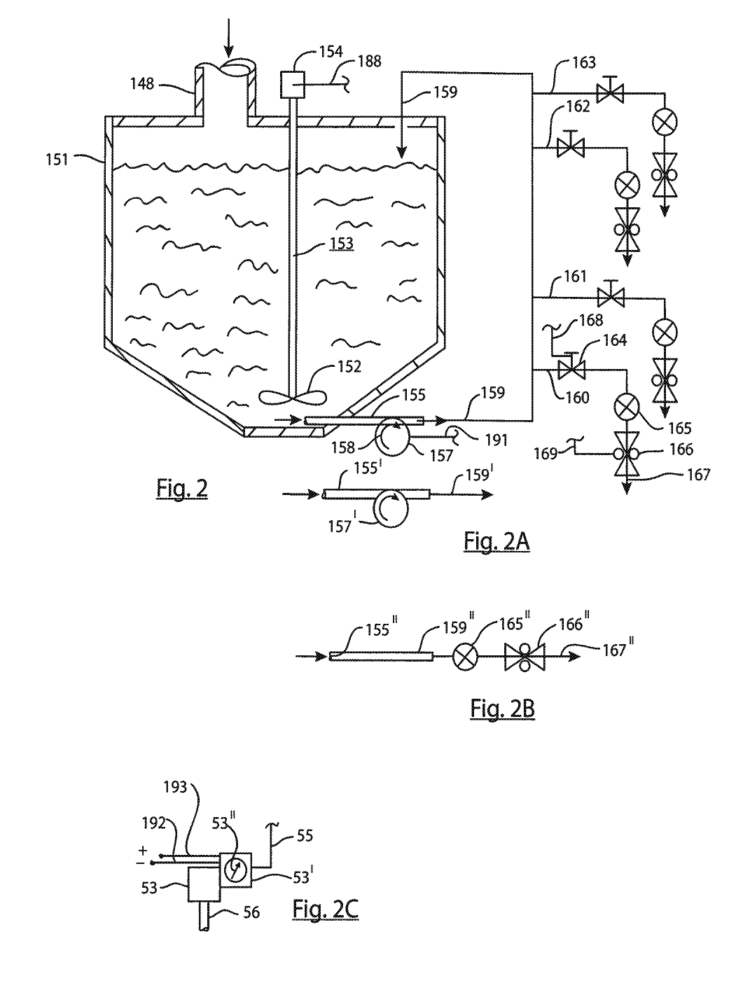

As shown in FIG. 2, within the tank 151 the powder material and water may be mixed via a mixer 152, preferably shaft mounted at 153 and driven from a motor 154, for discharge from the bottom of the mixing tank 151, into the discharge line 155. A pump or other impeller 157 may be driven in the direction of the arrow 158 shown, to discharge the mix via line 159 through one or more of a plurality of dosing assemblies 160, 161, 162 and/or 163.

Each dosing assembly 160-163 includes a valve 164, a preferably magnetic flowmeter 165 and a pinch valve 166 in a discharge dosing line 167, with the valves 164 each being preferably also connected to the computer 170, via an information feed line such as 168. The pinch valve 166 can also be connected to the computer 170 for computer-controlled operation via a control line such as line 169. The valves, such as 164 and 166 can also be manually operated if computer control is not desired.

The mix can also or alternatively be returned to the holding or storage tank 151 via line 159.

With reference now to FIG. 2A, an alternative to the discharge line 155 of FIG. 2 is illustrated, as discharge line 155′, having a pump or impeller 157′ in the line for delivery of the mix via line 159′ directly to a treatment process.

With reference to FIG. 2B, yet another alternative is provided for gravity flow of the mix via line 159″ from discharge line 155″ from the tank 151, delivering the mix through optional flowmeter 165″ and modulating pinch valve 166″ to a treatment process via line 167″.

The computer 170 may control the operations of the various components of the system 10, and preferably will be used to do so.

Referring now to FIG. 2C, when the powder material in the mixing tank 60 is a dry polymer, the electric motor 53 that drives the shaft 56 that turns the impeller in the mixing tank 60 of FIG. 1, is adjustable in its speed by means of a variable speed drive 53′ that is manually adjustable via a dial or the like 53″, with the variable speed drive 53′ receiving its electric power via electric lines 192 and 193. The manually adjustable variable speed drive 53′ can provide speed information via line 55 to the computer 170.

It will be understood that the mixing blade 57 that is driven by the shaft 56 is thus driven at gradually increasing speeds in order to avoid over-mixing the water and powder material when the powder material is a dry polymer, so as not to unduly breakup the chain of molecules the comprise the fragile polymer.

The process of arriving at the most desirable drive speed at any given time for the impeller 57 is an empirical process, by which the variable speed drive will preferably commence impeller rotation at a slow speed, and its speed will be gradually increased based upon operator observation and experimentation until the dry polymer and water are mixed to a level that the person operating the system determines is suitable for the desired purpose, based upon operator experience, and taking into account possible variations that may occur from bag-to-bag of polymer, as different bags 16 are replaced, from time to time. Thereafter, with experience, the computer 170 may be programmed to gradually increase the speed of the drive motor 53 to correspond with a gradual increase in speed that has been found to be desirable for the motor 53, to enable the mixing blade or impeller 57 to mix the dry polymer and water to a desired level, automatically, based upon the operator's empirical experience.

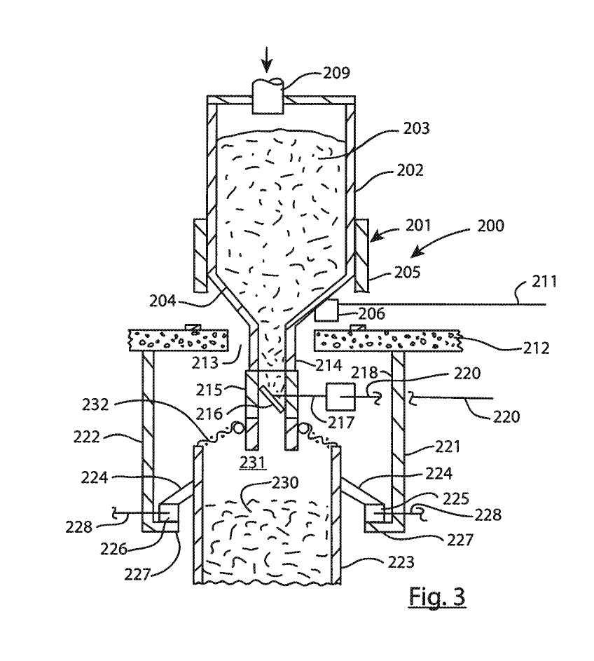

Referring now to FIG. 3, a silo-delivery alternative to the bag 16 delivery system for the powder material as described in FIG. 1, will now be presented.

A silo system 200 includes a silo mount 201 comprised of a preferably generally cylindrical silo wall 205, carried by a concrete or other floor 212 (with the cylindrical wall 205 being shown in broken form, for clarity), but it will be understood that the same will be extensive from the floor level 212, up through the portion 205 that engages the silo 202 itself.

The silo 202 contains powder material 203 therein, delivered via an inlet 209, in the direction of the arrow disposed thereabove, such that powder material 203 can be discharged via an outlet 214 thereof, disposed below the generally conical lower end 204 thereof. The silo discharge 214 is spaced from the floor 212 as shown at 213.

A vibrating motor 26 is provided, like that 23 of FIG. 1, controlled from the computer 170 via line 211, in the same manner that line 24 controls the motor 23 from the computer 170 in the embodiment of FIG. 1.

Beneath the discharge 214 from silo 202, a flapper or other valve 216 within valve mechanism 215, operated by operating rod 217 is motor driven at 218 via a control line 220, in the same manner that control line 30 controls the operation of valve member 26 via control line 30 from computer 170 in the embodiment of FIG. 1.

The feed hopper 223 is constructed similarly to the feed hopper 37 of the embodiment of FIG. 1, with supports 224, that in turn, rest on load cells 225, 226, connected to the information feed line 228, for transmitting information back to the computer 170 via line 228, in the same manner as transmission line 39 does for the load cells 34, 35, in the embodiment of FIG. 1.

The load cells 225, 226, rest upon the horizontal members 227 that are carried by the vertical supports 221, 222, in the same manner as similar feed hopper supports are carried from the floor 11 in the embodiment of FIG. 1, in that the support members 221, 222 in the embodiment of FIG. 3, are secured to and carried by the floor 212.

Thus, powder material 203 is thus permitted to enter the feed hopper 223 in the same manner as is explained above with respect to the embodiment of FIG. 1. Likewise, a foraminous screen, cloth or other filter 232 is provided at the upper end of the feed hopper 223, similar to that 38 of the embodiment of FIG. 1, to allow discharge of air from the zone 231 of the feed hopper 223.

It will thus be apparent that the embodiment of FIG. 3 presents a silo alternative to the bag delivery of the powder material described above with respect to FIG. 1.

It will be understood from the above, that when the powder material being mixed with water is powdered activated carbon, the mix that is thus formed will be a slurry, whereas, when the powdered material that is being mixed with water is a dry polymer, the mix that is formed will ordinarily be a solution of the dry polymer in water.

It will be apparent from the foregoing that various modifications may be made in the details of the operating components of the system 10, as well as in their operation, all within the spirit and scope of the invention as defined in the appended claims. It will be understood that the bag and silo delivery systems of FIGS. 1 and 3, for delivering the powder material to a feed hopper, are examples only. Similarly, the silo mount and bag mounting structures described are examples only, in that many variations of such mounting structures are possible, within the spirit and scope of the invention. Also, the vibrating means described in the form of an annulus surrounding the bag mounting structure and/or silo is an example only, in that any suitable vibrating structure may be used, for facilitating the shaking of the powder material out a discharge. Likewise, the various valving structures that are used throughout the embodiments of this invention are by way of example only, in that any suitable valving structures may be used in accordance with this invention. The feed hoppers and their foraminous screens may likewise take on various forms, as will the transport device for conveying the powder material from the feed hopper likewise be constructed in other manners. For example, in lieu of the auger for discharging the powder material from the feed hopper, a belt or other conveying mechanism may be used. Likewise, the structure of the holding or storage tank described with respect to FIGS. 2, 2A and 2B as well as its valving, discharge, and dosing stations may likewise take on various forms such as will accomplish the purposes of this invention. Also, in lieu of the pinch valve 166 described above, alternative forms of valves that will accomplish the purposes of this invention may be used, all within the scope of the claims wherein various features are broadly described as “means” for accomplishing the various functions. As used herein, where “means” are recited, followed by functional language, it is to be understood that such means encompasses any means that is able to perform the recited function, and is not limited to the specific structure disclosed herein as providing that means and its equivalents.

What is claimed is:

1. A process for mixing a powder material with water comprising the steps of:
(a) providing a powder material that is one of:
(i) a powdered activated carbon; and
(ii) a dry polymer;
(b) delivering the powder material to a feed hopper while evacuating sufficient air from the feed hopper to offset the amount of powder material being delivered to the feed hopper;
(c) transferring the powder material from the feed hopper to a mixing tank;
(d) delivering water to the mixing tank in such a way that the water mingles with and wets particles of the powder material entering the mixing tank;
(e) mixing the powder material and water in the mixing tank;
(f) including at least one of the steps of:
(i) delivering the water to the mixing tank through a wetting ring;
(ii) as part of the evacuating step, evacuating air from the feed hopper to atmosphere, through a foraminous member;
(iii) wherein the delivery of powder material to the feed hopper is via a container that is a bag;
(iv) wherein the delivery of powder material to the feed hopper is via a container that is a silo;
(v) supporting and monitoring the aggregate weight of the feed hopper and the powder material on at least one load cell, and communicating the aggregate weight to a computer; and
(vi) vibrating the container having the powder material therein to facilitate discharge of powder material therefrom into the feed hopper; and
(g) discharging the mix of powder material and water from the mixing tank.

2. The process of claim 1, wherein at least one of the delivering step of clause (b), the transferring step of clause (c), the delivering step of clause (d), the vibrating step of clause (f) (v) and the discharging step of clause (g) are controlled via a computer.

3. The process of claim 1, wherein the powder material is powdered activated carbon.

4. The process of claim 1, wherein the powder material is a dry polymer.

5. The process of claim 1, wherein the transfer of the powder material from the feed hopper to the mixing tank is via an auger.

6. The process of claim 1, wherein the delivery of water to the mixing tank is through a wetting ring having multiple nozzles for spraying and wetting the powder material entering the mixing tank.

7. The process of claim 1, wherein the discharging step includes any one of:
(i) discharging the mix of powder material and water to at least one dosing station;
(ii) discharging the mix of powder material and water directly to a treatment station; and
(iii) discharging at least a portion of the mix of powder material and water to a holding tank.

8. The process of claim 1, wherein the delivery of water to the mixing tank is through a wetting ring.

9. The process of claim 1, wherein, as part of the evacuating step, evacuating air from the feed hopper to atmosphere, through a foraminous member.

10. The process of claim 1, wherein the delivery of powder material to a feed hopper is via a container that is a bag.

11. The process of claim 1, wherein the delivery of powder material to a feed hopper is via a container that is a silo.

12. The process of claim 1, including the step of vibrating the container having the powder material to facilitate discharge of powder material therefrom into the feed hopper.

13. The process of claim 3, wherein the mixing step includes gradually varying the mixing speed of the dry polymer and water so as to avoid over-mixing the water and dry polymer.

14. The process of claim 3, wherein the transfer of the powder material from the feed hopper to the mixing tank is via an auger, wherein the delivery of water to the mixing tank is through a wetting ring having multiple nozzles for spraying and wetting the powder material entering the mixing tank, wherein the discharging step includes any one of:
(i) discharging the mix of powder material and water to at least one dosing station;
(ii) discharging the mix of powder material and water directly to a treatment station; and
(iii) discharging at least a portion of the mix of powder material and water to a holding tank,
and including the step of vibrating the container having the powder material therein to facilitate discharge of powder material therefrom into the feed hopper.

15. The process of claim 4, wherein the transfer of the powder material from the feed hopper to the mixing tank is via an auger, wherein the delivery of water to the mixing tank is through a wetting ring having multiple nozzles for spraying and wetting the powder material entering the mixing tank, wherein the discharging step includes any one of:
(i) discharging the mix of powder material and water to at least one dosing station;
(ii) discharging the mix of powder material and water directly to a treatment station; and
(iii) discharging at least a portion of the mix of powder material and water to a holding tank,
and including the step of vibrating the container having the powder material therein to facilitate discharge of powder material therefrom into the feed hopper.

16. Apparatus for mixing a powder material with water comprising:
(a) means providing a powder material that is one of
(i) a powdered activated carbon; and
(ii) a dry polymer;
(b) means for delivering the powder material to a feed hopper including evacuation means for evacuating sufficient air from the feed hopper to offset the amount of powder material being delivered to the feed hopper;
(c) a mixing tank and means transferring the powder material from the feed hopper to the mixing tank;
(d) means for delivering water to the mixing tank in such a way that the water mingles with and wets particles of the powder material entering the mixing tank;
(e) means for mixing the powder material and water in the mixing tank;
(f) including at least one of:
(i) means delivering the water to the mixing tank through a wetting ring;
(ii) as part of the evacuation means, means evacuating air from the feed hopper to atmosphere, through a foraminous member;
(iii) wherein the means for delivering the powder material to the feed hopper includes a container that is a bag;
(iv) wherein the means for delivering the powder material to the feed hopper includes a container that is a silo;
(v) means for supporting and monitoring the aggregate weight of the feed hopper and the powder material on at least one load cell, and means communicating the aggregate weight to a computer; and
(vi) means for vibrating the container having the powder material therein to facilitate discharge of powder material therefrom into the feed hopper; and
(g) means for discharging the mix of powder material and water from the mixing tank.

17. The apparatus of claim 16, including a computer for controlling at least one of the means for delivering of clause (b), the means transferring of clause (c), the means for delivering of clause (d), the means delivering water of clause (f) (i), the means for vibrating of clause (g) (vi) and the means for discharging of clause (g).

18. The apparatus of claim 16, wherein the powder material is powdered activated carbon.

19. The apparatus of claim 16, wherein the powder material is a dry polymer.

20. The apparatus of claim 16, wherein the means transferring for the powder material from the feed hopper to the mixing tank is via an auger.

21. The apparatus of claim 16, wherein means for delivering water to the mixing tank is through a wetting ring having multiple nozzles for spraying and wetting the powder material entering the mixing tank.

22. The apparatus of claim 16, wherein the means for discharging includes any one of:
(i) means for discharging the mix of powder material and water to at least one dosing station;
(ii) means for discharging the mix of powder material and water directly to a treatment station; and
(iii) means for discharging at least a portion of the mix of powder material and water to a holding tank.

23. The apparatus of claim 16, wherein the means for delivering water to the mixing tank is through a wetting ring.

24. The apparatus of claim 16, wherein, as part of the evacuation means, means are provided for evacuating air from the feed hopper to atmosphere, through a foraminous member.

25. The apparatus of claim 16, wherein the means for delivering powder material to the feed hopper is via a container that is a bag.

26. The apparatus of claim 16, wherein the means for delivering of powder material to the feed hopper is via a container that is a silo.

27. The apparatus of claim 19, including means for vibrating the container having the powder material to facilitate discharge of powder material therefrom into the feed hopper.

28. The apparatus of claim 19, wherein the means for mixing includes means for gradually varying the mixing speed of the dry polymer and water so as to avoid over-mixing the water and dry polymer.

29. The apparatus of claim 18, wherein the means for transferring the powder material from the feed hopper to the mixing tank is via an auger, wherein the means for delivering water to the mixing tank is through a wetting ring having multiple nozzles for spraying and wetting the powder material entering the mixing tank, wherein the means for discharging includes any one of:
(i) means for discharging the mix of powder material and water to at least one dosing station;
(ii) means for discharging the mix of powder material and water directly to a treatment station; and
(iii) means for discharging at least a portion of the mix of powder material and water to a holding tank,
and including means for vibrating the container having the powder material therein to facilitate discharge of powder material therefrom into the feed hopper.

30. The apparatus of claim 19, wherein the means for transferring the powder material from the feed hopper to the mixing tank is via an auger, wherein the means for delivering water to the mixing tank is through a wetting ring having multiple nozzles for spraying and wetting the powder material entering the mixing tank, wherein the means for discharging includes any one of:
(i) means for discharging the mix of powder material and water to at least one dosing station;
(ii) means for discharging the mix of powder material and water directly to a treatment station; and
(iii) means for discharging at least a portion of the mix of powder material and water to a holding tank,
and including means for vibrating the container having the powder material therein to facilitate discharge of powder material therefrom into the feed hopper.
